(19) United States
(12) Patent Application Publication
(10) Pub. No.: US 2012/0297297 A1
(43) Pub. Date: Nov. 22, 2012

(54) DOCUMENT PROVIDING SYSTEM, ELECTRONIC DEVICE AND DISPLAY PANEL

(76) Inventors: Cheng-Te Tseng, Taipei City (TW); Chang-Hung Lee, Yun-Lin Hsien (TW)

(21) Appl. No.: 13/472,506

(22) Filed: May 16, 2012

(30) Foreign Application Priority Data
May 16, 2011 (TW) 100117031

(51) Int. Cl. G06F 17/00

(52) U.S. Cl. 715/273

(57) ABSTRACT

A document providing system includes a server and an electronic device. The server provides a first document that the electronic device requests. The electronic device includes a communication unit, a display panel and a processing unit. The processing unit is electrically coupled to the communication unit and the display panel. The communication unit communicates with the server. The display panel includes a memory which stores a unique identification code, and the unique identification code records a first panel information related the display panel. The processing unit transmits the unique identification code to the server when the electronic device requests the first document from the server. The server then converts the first document into a second document suitable to be displayed by the display panel according to the first panel information, and transmits the second document to the electronic device.

### BACKGROUND OF THE INVENTION

1. Field of the Invention

The invention relates to a document providing system, an electronic device and a display panel, more particularly, to a display panel in which a unique identification code is stored, an electronic device and a document providing system using the display panel, wherein the unique identification code records panel information related to the display panel.

2. Description of the Prior Art

General speaking, many electronic devices, such as the mobile phone, the personal digital assistant (PDA), the laptop and the electronic book, etc., are incorporated with the display panels so as to display information for the user to read. Currently, there are many kinds of the display panels, such as the cathode ray tube (CRT), the plasma display panel (PDP), the liquid crystal display (LCD), the electronic paper display (EPD), the organic light-emitting diode (OLED) and the mirasol display, etc.

However, since the panel information related to each display panel is different, such as the panel manufacturer's name, the panel category, the best resolution, the color depth, the maximum brightness, the maximum contrast and the ratio of the panel width to the panel height, etc., a document downloaded from the internet may not be displayed by each display panel in a status suitable for reading. Accordingly, after downloading a document, the user needs to adjust the settings of the display panel for the display panel to display the document in a status suitable for reading. It would be a trouble for a user who is not familiar with the setting of the display panel. Besides, it is pretty common that an un-authorized document is shared as the computer, the internet and the document sharing tool become more and more popular. It is also important to effectively enforce the copyright protection in the electronic devices.

### SUMMARY OF THE INVENTION

Therefore, an objective of the invention is to provide a display panel in which a unique identification code is stored, an electronic device and a document providing system using the same so as to resolve the aforementioned problems.

According to one embodiment, a document providing system of the invention comprises a server and an electronic device. The server provides a first document that the electronic device requests. The electronic device comprises a communication unit, a display panel and a processing unit, wherein the processing unit is electrically coupled to the communication unit and the display panel. The communication unit communicates with the server. The display panel comprises a memory, and the memory stores a unique identification code which records a first panel information related to the display panel. The processing unit transmits the unique identification code to the server when the electronic device requests the first document from the server. The server converts the first document into a second document suitable for being displayed by the display panel according to the first panel information, and transmits the second document to the electronic device. The second document accordingly can be displayed by the display panel of the electronic device in a status suitable for reading.

According to another embodiment, an electronic device of the invention comprises a communication unit, a display panel and a processing unit, wherein the processing unit is electrically coupled to the communication unit and the display panel. The communication unit communicates with a server, and the server provides a first document that the electronic device requests. The display panel comprises a memory, and the memory stores a unique identification code which records a first panel information related to the display panel. The processing unit transmits the unique identification code to the server when the electronic device requests the first document from the server. The server converts the first document into a second document suitable for being displayed by the display panel according to the first panel information, and transmits the second document to the electronic device.

In the above embodiments, when the server converts the first document into the second document, the server may write the unique code into the second document. Therefore, when the electronic device receives the second document, the processing unit will first determine whether the unique identification code written in the second document meets the unique identification code of the display panel. If it meets, the processing unit will then control the display panel to display the second document. Otherwise, the processing unit will not control the display panel to display the second document.

According to another embodiment, a display panel of the invention comprises a memory, and the memory stores a unique identification code which records the panel information related to the display panel.

As mentioned in the above, according to the invention the memory in the display panel of the electronic device stores a unique identification code, and the unique identification code records the panel information related to the display panel. When the user downloads a document from the server via the electronic device, the electronic device will first transmit the unique identification code stored in the display panel to the server when the electronic device requests the document from the server. The server then converts the document into another document suitable for being displayed by the display panel according to the panel information of the unique identification code, and transmits the converted document to the electronic device. Hence, the document provided by the server can be displayed by the display panel of the electronic device in a status suitable for reading.

Further, when the server converts the document, the server may write the unique identification code in the document. When the electronic device receives the document provided by the server, the electronic device will determine whether the unique identification code written in the document meets the unique identification code of the display panel. Only when it meets, the document can be displayed by the display panel of the electronic device. Otherwise, the document can not be displayed by the display panel of the electronic device. Through this mechanism, the copyright protection can be effectively enforced.

These and other objectives of the present invention will no doubt become obvious to those of ordinary skill in the art after they read the following detailed description of the preferred embodiment that is illustrated in the various figures and drawings.

### BRIEF DESCRIPTION OF THE DRAWINGS

FIG. 1 is a schematic diagram illustrating a document providing system according to one embodiment of the invention.

FIG. 2 is a schematic diagram illustrating the look up table shown in FIG. 1.

FIG. 3 is a schematic diagram illustrating an electronic device according to another embodiment of the invention.

### DETAILED DESCRIPTION

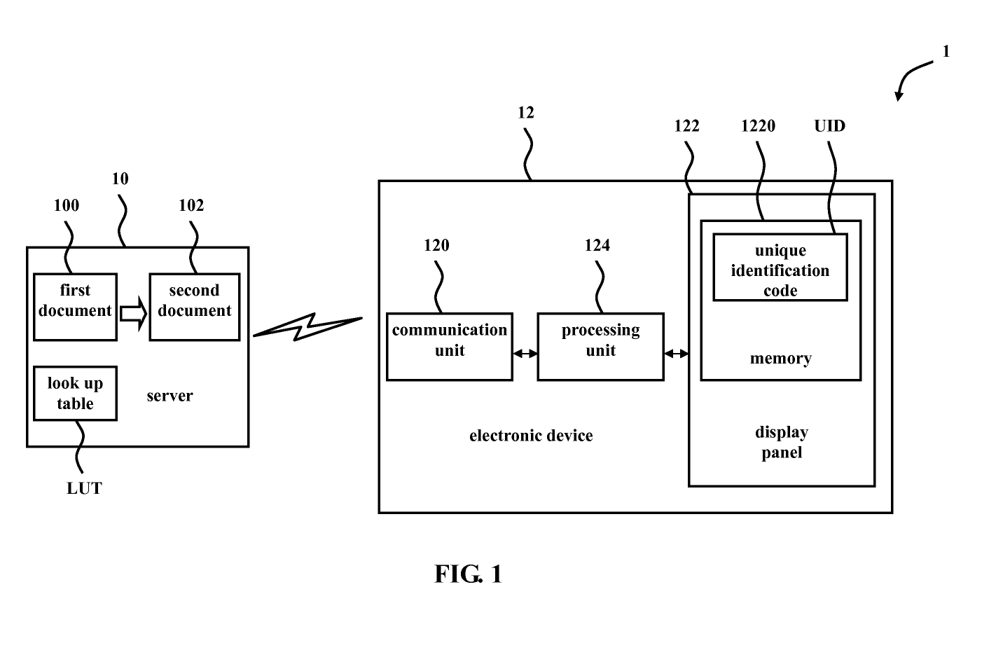

Referring to FIG. 1, FIG. 1 is a schematic diagram illustrating a document providing system 1 according to one embodiment of the invention. As shown in FIG. 1, the document providing system 1 comprises a server 10 and an electronic device 12. In this embodiment, the server 10 may be a general server for providing a first document 100. The electronic device 12 comprises a communication unit 120, a display panel 122 and a processing unit 124, wherein the processing unit 124 is electrically coupled to the communication unit 120 and the display panel 122.

In this embodiment, the electronic device 12 may be a mobile phone, a personal digital assistant (PDA), a laptop, an electronic book or other electronic device with a display panel. The electronic device 12 can communicate with the server 10 by the communication unit 120. In practical application, the communication unit 120 may be a wireless communication module for bluetooth, WiFi or infrared rays, may be coupled to a sensor of the wireless sensor network (WSN), such as Zigbee, or may be coupled to a wireless communication module of a mobile phone network communication system, such as GSM/GPRS and HSDPA/HSUP, etc. The electronic device 12 therefore may communicate with the server 10 via the communication unit 120 in the way of wireless communication. In another embodiment, the communication unit 120 may be a network card so that the electronic device 12 may communicate with the server 10 in the way of wire or wireless communication.

Besides, the display panel 122 may be a cathode ray tube (CRT), a plasma display panel (PDP), a liquid crystal display (LCD), an electronic paper display (EPD), an organic light-emitting diode (OLED) or a mirasol display, etc. The processing unit 124 may be a processor a controller with the ability of data processing. General speaking, some hardware and software may also be incorporated in the electronic device 12 for normal operation, such as a memory, a storage device, a power supply device and a operating system, etc., depending on the practical application. The function of the aforementioned hardware and software are well known and can be implemented by those of ordinary skill in the art, and therefore are not described in details herein.

As shown in FIG. 1, the display panel 122 comprises a memory 1220 which stores a unique identification code UID, and the unique identification code UID records a first panel information related to the display panel 122. In practical application, the memory 1220 may be a read only memory (ROM) incorporated in the display panel 122. In this embodiment, the first panel information may comprise at least one of the followings: a panel manufacturer's name, a panel category, a best panel resolution, a panel color depth, a maximum panel brightness, a maximum panel contrast and a ratio of a panel width to a panel height.

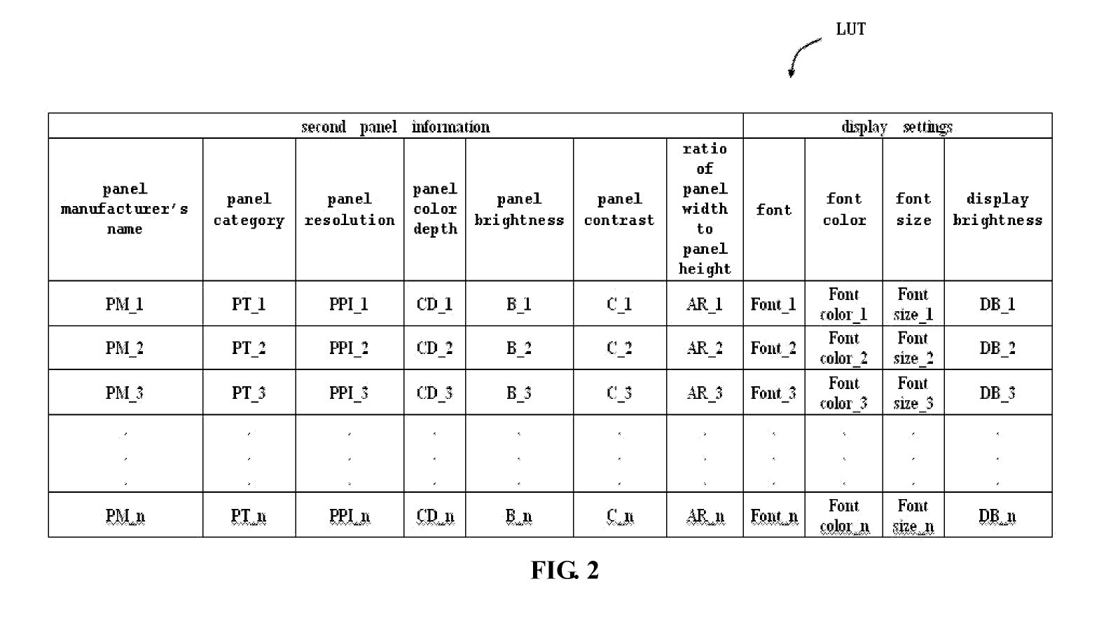

Besides, the server 10 stores a look up table LUT. Referring to FIG. 2, FIG. 2 is schematic diagram illustrating the lookup table LUT shown in FIG. 1. As shown in FIG. 2, the lookup table LUT records a plurality of display settings and a plurality of second panel information, and each of the display settings corresponds to at least one of the second panel information. In this embodiment, each display setting may comprise at least one of the followings: a font, a font color, a font size and a display brightness. Each of the plurality of second panel information may comprise at least one of the followings: a panel manufacturer's name, a panel category, a panel resolution, a panel color depth, a panel brightness, a panel contrast and a ratio of a panel width to a panel height.

Please note that the contents of the first panel information, the second panel information and the display settings are not limited to aforementioned examples. In other words, the contents of the first panel information, the second panel information and the display settings may be increased or decreased. Further, the panel resolution, the panel color depth, the panel brightness, the panel contrast and the ratio of the panel width to the panel height in the second panel information may be a value or a range, depending on the practical application.

When the user uses the electronic device 12 to download the first document 100 from the server 10, the processing unit 124 of the electronic device 12 first transmits the unique identification code UID stored in the display panel 122 to the server 10 via the communication unit 120 when the electronic device 12 requests the first document 100 from the server 10. When the server 10 receives the unique identification code UID from the electronic device 12, the server 10 compares the first panel information in the unique identification code UID with the second panel information in the look up table LUT so as to select one display setting corresponding to the unique identification code UID of the display panel 122 among the plurality of the display settings, i.e. to select the display setting suitable for the display panel 122 among the plurality of the display settings. The server then converts the first document 100 into a second document 102 according to the selected display setting, and transmits the second document 102 to the electronic device 12. The second document 102 provided by the server 10 therefore can be displayed by the display panel 122 of the electronic device 12 in a status suitable for reading.

For example, if the manufacturer's name of the display panel recorded in the unique identification code UID is “PM_1,” the panel category is “PT_1,” the best resolution of the panel is “PPI_1,” the color depth of the panel is “CD_1,” the maximum brightness of the panel is “B_1,” the best contrast of the panel is “C_1” and the ratio of the panel width to the panel height is “AR_1,” the display setting that the server 10 uses to converts the first document 100 into the second document 102 would be the font “Font_1,” the font color “Font color_,” the font size “Font size_1” and the display brightness “DB_1.” Therefore, after the electronic device 12 downloads the second document 102, the processing unit 124 controls the display panel 122 to display the second document 102 by the font “Font_1,” the font color “Font color_1,” the font size “Font size_” and the display brightness “DB_1.”

In another embodiment, aforementioned unique identification code UID may further record a serial number. In practical application, the serial number may be generated based on a customer code and a production date, etc. or their combination. When the server 10 converts the first document 100 into the second document 102, the server 10 may write the unique identification code UID in the second document 102. In this way, when the electronic device 12 receives the second document 102, the processing unit 124 will first determine whether the serial number and/or the first panel information in the unique identification code UID of the second document 102 meet(s) the serial number and/or the first panel information in the display panel 122. If it meets, the processing unit 124 then controls the display panel 122 to display the second document 102. If it does not meet, the processing unit 124 will not control the display panel 122 to display the second document 102.

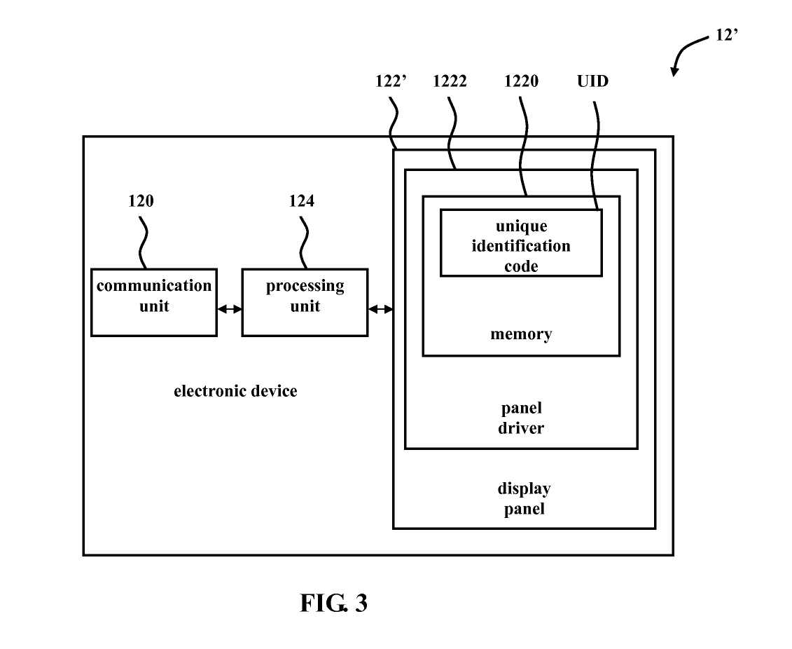

Referring to FIG. 3, FIG. 3 is a schematic diagram illustrating an electronic device 12′ according to another embodiment of the invention. The main differences between the electronic device 12′ and the electronic device 12 are that the display panel 122′ of the electronic device 12′ further comprises a panel driver 1222, and that the memory 1220 is integrated in the panel driver 1222, as shown in FIG. 3. In practical application, the memory 1220 may be a read only memory embedded in the panel driver 1222. Please note that the elements marked with the same numbers shown in FIG. 3 as what are shown in FIG. 1 work in the same way, and therefore are not described in details herein.

Compare with the prior art, in this invention a unique identification code is stored in the memory of display panel of the electronic device, and the unique identification code records the panel information related to the display panel. When the user uses the electronic device to download a document from the server, the electronic device will first transmit the unique identification code stored in the display panel to the server when the electronic device requests the document from the server. The server then converts the document into another document suitable to be displayed by the display panel according to the panel information recorded in the unique identification code, and transmits the converted document to the electronic device. Through this way, the document provided by the server can be displayed by the display panel of the electronic device in a status suitable for reading.

In addition, the server may write the unique identification code in the document when the server converts the document. When the electronic device receives the document provided by the server, the electronic device may first determine whether the unique identification code written in the document meets the unique identification code of the display panel. If it meets, the document can be displayed by the display panel of the electronic device. Otherwise, the document can not be displayed by the display panel of the electronic device. Via this mechanism, the copy protection can be effectively enforced

Those skilled in the art will readily observe that numerous modifications and alterations of the device and method may be made while retaining the teachings of the invention.

What is claimed is:

1. A document providing system comprising:
a server, providing a first document; and
an electronic device, comprising:
a communication unit, communicating with the server;
a display panel, comprising a memory which stores a unique identification code, the unique identification code records a first panel information related to the display panel; and
a processing unit, electrically coupled to the communication unit and the display panel;
wherein the processing unit transmits the unique identification code to the server when the electronic device requests the first document from the server, and the server converts the first document into a second document suitable to be displayed by the display panel according to the first panel information and then transmits the second document to the electronic device.

2. The document providing system of claim 1, wherein the first panel information comprises at least one of the followings: a panel manufacturer's name, a panel category, a best panel resolution, a panel color depth, a maximum panel brightness, a maximum panel contrast and a ratio of a panel width to a panel height.

3. The document providing system of claim 1, wherein when the server converts the first document into the second document, the server writes the unique identification code in the second document.

4. The document providing system of claim 1, wherein the unique identification code further records a serial number.

5. The document providing system of claim 1, wherein the server stores a lookup table, the lookup table records a plurality of display settings and a plurality of second panel information, each of the display settings corresponds to at least one of the plurality of second panel information, and when the server receives the unique identification code from the electronic device, the server compares the first panel information with the plurality of second panel information, select one display setting suitable for the display panel among the plurality of display settings, and converts the first document into the second document according to the selected display setting.

6. The document providing system of claim 5, wherein each of the plurality of display settings comprises at least one of the followings: a font, a font color, a font size and a display brightness, and each of the plurality of second panel information comprises at least one of the followings: a panel manufacturer's name, a panel category, a panel resolution, a panel color depth, a panel brightness, a panel contrast and a ratio of a panel width to a panel height.

7. The document providing system of claim 1, wherein the display panel further comprises a panel driver, and the memory is integrated in the panel driver.

8. An electronic device, comprising:
a communication unit, communicating with a server, the server providing a first document;
a display panel, comprising a memory which stores a unique identification code, the unique identification code records a first panel information related to the display panel; and
a processing unit, electrically coupled to the communication unit and the display panel;
wherein the processing unit transmits the unique identification code to the server when the electronic device requests the first document from the server, and the server converts the first document into a second document suitable to be displayed by the display panel according to the first panel information and then transmits the second document to the electronic device.

9. The electronic device of claim 8, wherein the first panel information comprises at least one of the followings: a panel manufacturer's name, a panel category, a best panel resolution, a panel color depth, a maximum panel brightness, a maximum panel contrast and a ratio of a panel width to a panel height.

10. The electronic device of claim 8, wherein when the server converts the first document into the second document, the server writes the unique identification code in the second document.

11. The electronic device of claim 8, wherein the unique identification code further records a serial number.

12. The electronic device of claim 8, wherein the server stores a look up table, the look up table records a plurality of display settings and a plurality of second panel information, each of the display settings corresponds to at least one of the plurality of second panel information, and when the server receives the unique identification code from the electronic device, the server compares the first panel information with the plurality of second panel information, select one display setting suitable for the display panel among the plurality of display settings, and converts the first document into the second document according to the selected display setting.

13. The electronic device of claim 12, wherein each of the plurality of display settings comprises at least one of the followings: a font, a font color, a font size and a display brightness, and each of the plurality of second panel information comprises at least one of the followings: a panel manufacturer's name, a panel category, a panel resolution, a panel color depth, a panel brightness, a panel contrast and a ratio of a panel width to a panel height.

14. The electronic device of claim 8, wherein the display panel further comprises a panel driver, and the memory is integrated in the panel driver.

15. A display panel, comprising a memory which stores a unique identification code, the unique identification code records a panel information related to the display panel.

16. The display panel of claim 15, wherein the panel information comprises at least one of the followings: a panel manufacturer's name, a panel category, a best panel resolution, a panel color depth, a maximum panel brightness, a maximum panel contrast and a ratio of a panel width to a panel height.

17. The display panel of claim 15, wherein the unique identification code further records a serial number.

18. The display panel of claim 15, further comprising a panel driver, wherein the memory is integrated in the panel driver.
